(19) United States
(12) Patent Application Publication
(10) Pub. No.: US 2016/0311941 A1
(43) Pub. Date: Oct. 27, 2016

(54) PROCESS FOR THE PREPARATION OF COLESEVELAM

(71) Applicant: CHEMI SPA, Cinisello Balsamo (MI) (IT)

(72) Inventors: Mauro Gaboardi, Novara (IT); Alessandro Baruto, Tromello (PV) (IT); Marta Castaldi, Sizzano (NO) (IT)

(21) Appl. No.: 15/104,330

(22) PCT Filed: Dec. 16, 2014
(86) PCT No.: PCT/IB2014/066948

§ 371 Date: Jun. 14, 2016

(30) Foreign Application Priority Data
Dec. 19, 2013 (IT) MI2013A002132

(51) Int. Cl. C08F 8/44; C08J 3/24

(52) U.S. Cl. CPC C08F 8/44; C08J 3/24; C08J 2339/00

(57) ABSTRACT

The present invention relates to a new process for the synthesis of Colesevelam, which is used in therapy in cases of hypercholesterolemia due to low density lipoproteins. Said process comprises the reaction, in a basic environment, of polyallylamine with: i) at least one alkylating agent of formula X—(CH₂)₉—CH₃ and at least one alkylating agent of formula Y—(CH₂)₆—N⁺ (CH₃)₃Z⁻, wherein X and Y are each independently a leaving group, and Z is a halogen; and ii) at least one crosslinking agent. The present invention also relates to the Colesevelam obtainable by the above process.

The present invention relates to a new process for the synthesis of Colesevelam, which is used in therapy in cases of hypercholesterolemia due to low density lipoproteins.

Said process comprises the reaction, in a basic environment, of polyallylamine with: i) at least one alkylating agent of formula X—(CH₂)₉—CH₃ and at least one alkylating agent of formula Y—(CH₂)₆—N⁺(CH₃)₃Z⁻, wherein X and Y are each independently a leaving group, and Z is a halogen; and ii) at least one crosslinking agent.

The present invention also relates to the Colesevelam obtainable by the above process.

### FIELD OF THE INVENTION

The present invention relates to a new process for the synthesis of Colesevelam, which is used in therapy in cases of hypercholesterolemia due to low density lipoproteins.

Low-density lipoproteins (LDL) are proteins consisting of low protein content and high amount of lipids (mainly esterified cholesterol). They are the product of the metabolism of hepatic synthesis VLDL and they transport cholesterol from the liver to the tissues, where it is used for a variety of processes.

By the term hypercholesterolemia, it is meant an excess of cholesterol in the blood, more specifically an increase in the cholesterol carried by LDL; when these lipoproteins are present in too high concentrations, their accumulation in the arterial walls promotes the development of atherosclerosis. As a result, hypercholesterolemia due to LDL is one of the major risk factors for cardiovascular diseases.

Colesevelam is a polymer capable of reducing the lipids level, by binding bile acids in the intestine, thereby preventing their reabsorption. It is indicated, in addition to diet and physical exercise, to lower LDL cholesterol and to improve glycemic control in adults with type 2 diabetes, also in combination with a statin. Colesevelam is a compound of formula (I)

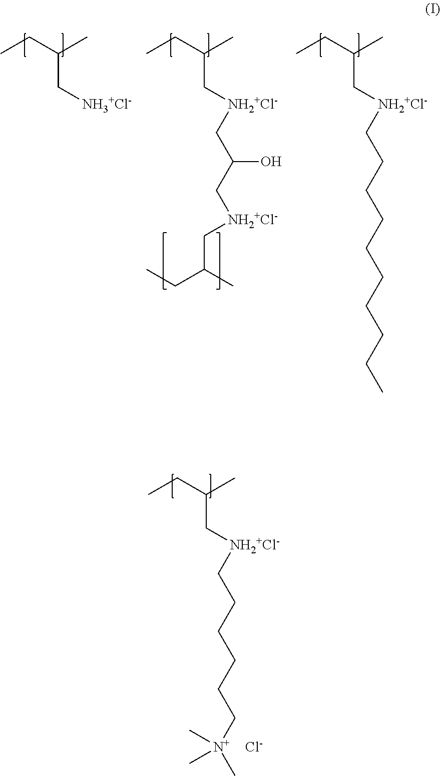

described in EP0764174B1, and it is commercially available under the trade name Welchol® or Cholestagel®.

In the literature, few documents describe the synthesis of Colesevelam.

EP0764174B1 describes the synthesis of Colesevelam starting from a polymer consisting of the repetitive units of formula A, B e C

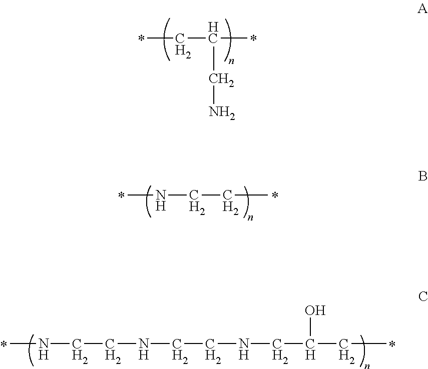

which is crosslinked before the following alkylation, preferably by using two alkylating agents. The two alkylating agents are of formula:
RX, wherein R represents a C₁-C₂₀ alkyl group and X represents a leaving group;
R′X, wherein R′ represents a C₁-C₂₀ alkyl ammonium group and X represents a leaving group.

U.S. Pat. No. 7,399,821 describes a process for the synthesis of alkylated and crosslinked polymeric salts, comprising the reaction of polyallylamine hydrochloride with epichlorohydrin, followed by reaction with 1-bromodecane and (6-bromohexyl)-trimethylammonium bromide.

U.S. Pat. No. 7,148,319 describes a process for the synthesis of crosslinked polyallylamines, comprising the deprotonation of a gelled polymer, the addition of one or more alkylating agents, and the subsequent re-protonation by means of a mineral acid. The starting polymer is obtained by polymerization and crosslinking in the presence of base.

U.S. Pat. No. 7,105,631 describes a process for the synthesis of a crosslinked amine polymer, comprising the synthesis of an aqueous solution of a starting polymer with a crosslinking agent, and subsequent alkylation in methanol, in the presence of a haloalkylammonium salt.

There remains, therefore, the need to find an alternative process for the synthesis of Colesevelam that allows to optimize the production time, reducing the processing steps and the quantities of solvents used.

### SUMMARY OF THE INVENTION

A new process for the synthesis of Colesevelam has now surprisingly been found, which does not start from crosslinked polyallylamine, as in the processes known in the art, but directly from polyallylamine in the presence of alkylating and crosslinking agents. Colesevelam obtained according to the process object of the present invention is compliant with USP Pending Monograph Draft 1.

The process of the present invention, advantageously, allows to simplify the industrial operations for the synthesis of Colesevelam, by not actually requiring the isolation of crosslinked polyallylamine or other intermediates, by substantially reducing the quantities of solvents used, and by limiting the operations of purification and isolation only to the final filtration and subsequent washing.

Consequently, the process of the present invention has a lower environmental impact compared to the processes known in the art, and it is therefore highly economical and industrially competitive.

It is therefore an object of the present invention a process for the synthesis of Colesevelam, comprising the reaction in a basic environment of polyallylamine with: i) at least one alkylating agent of formula X—(CH₂)₉—CH₃ and at least one alkylating agent of formula Y—(CH₂)₆—N⁺(CH₃)₃Z⁻, wherein X and Y are each independently a leaving group, and Z is a halogen; and ii) at least one crosslinking agent.

The present invention finally relates to Colesevelam obtainable by the above process.

### DETAILED DESCRIPTION OF THE INVENTION

The present invention relates to a process for the synthesis of Colesevelam, comprising the reaction in a basic environment of polyallylamine with: i) at least one alkylating agent of formula X—(CH₂)₉—CH₃ and at least one alkylating agent of formula Y—(CH₂)₆—N⁺(CH₃)₃Z⁻, wherein X and Y are each independently a leaving group, and Z is a halogen; and ii) at least one crosslinking agent.

According to the present invention, the preferred X and Y leaving groups are selected from a halogen or a group of formula —OSO₂R, wherein R is selected from trifluoromethyl, p-tolyl, methyl, m-nitro-phenyl; preferably said leaving groups are bromine.

Preferably, the group Z is bromine.

According to a preferred embodiment, said alkylating agent of formula X—(CH₂)₉—CH₃ is 1-bromodecane.

According to a further preferred embodiment, said alkylating agent of formula Y—(CH₂)₆—N⁺(CH₃)₃Z⁻ is (6-bromoesil)-trimethylammonium bromide.

The polyallylamine is alkylated and crosslinked in a basic environment, in a polar solvent or a mixture of polar solvents.

To obtain the basic environment, any base known to the person skilled in the art can be used. Preferably, the base is an inorganic base, more preferably, sodium or potassium hydroxide, sodium or potassium carbonate, even more preferably sodium hydroxide. Preferably, the process is carried out at a pH ranging between 8 and 14.

The process of the present invention can be carried out in any polar solvent known to the person skilled in the art. The polar solvent is preferably selected from water and a nitrile, more preferably acetonitrile, or mixtures thereof; even more preferably a mixture of water and acetonitrile.

The crosslinking agent is preferably selected from compounds of formula:

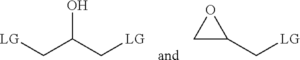

wherein LG is a leaving group.

The leaving group LG is preferably selected from a halogen or a group of formula —OSO₂R, wherein R is selected from trifluoromethyl, p-tolyl, methyl, m-nitro-phenyl; preferably, said leaving group is chlorine, bromine or p-toluensulphonate.

A preferred compound of formula

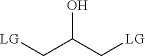

according to the present invention, is 1,3-dichloropropan-2-ol.

A compound of formula

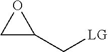

preferred according to the present invention, is epichlorohydrin, glycidyl tosilate or epibromohydrin.

The process of the present invention is carried out at a temperature ranging between 20° C. and the reflux temperature of the solvent, preferably between 65° C. and 70° C.

According to a first aspect of the present invention, said at least one alkylating agent of formula X—(CH₂)₉—CH₃, said at least one alkylating agent of formula Y—(CH₂)₆—N⁺(CH₃)₃Z⁻, and said at least one crosslinking agent are reacted with polyallylamine simultaneously. In this context, the term “simultaneously” means that the alkylating agents and the crosslinking agent are added to the polyallylamine, or otherwise put in contact with the polyallylamine, simultaneously, or within a short interval of time, depending on the operational procedures and/or the industrial equipment available, in order to be present simultaneously in the same reaction environment.

According to a second aspect of the present invention, said at least one alkylating agent of formula X—(CH₂)₉—CH₃ and said at least one alkylating agent of formula Y—(CH₂)₆—N⁺(CH₃)₃Z⁻ are reacted with polyallylamine before said crosslinking agent. According to a preferred environment, said crosslinking agent is reacted with the intermediate thus obtained without isolation of the same; in particular, said crosslinking agent can be added to the reaction mixture after a period of time comprised between 30 and 180 minutes, preferably between 45 and 90 minutes, after the addition of said alkylating agents.

Once the reaction is completed, the solid obtained is isolated by filtration. The filtered solid is then suspended in water, and the pH is adjusted to acidic values by addition of hydrochloric acid.

The Colesevelam thus obtained can be isolated using separation techniques well known to the person skilled in the art, such as precipitation, filtration with or without pressure and/or under vacuum, crystallization, centrifugation, decantation, and the like.

In a preferred embodiment of the present invention, the process is carried out in a basic environment obtained by addition of sodium hydroxide to a polyallylamine salt, in the presence of the alkylating agents 1-bromodecane and (6-bromohexyl)-trimethylammonium bromide, and of a crosslinking agent selected from glycidyl tosilate and epichlorohydrin.

In another preferred embodiment of the present invention, the process is carried out in a basic environment obtained by addition of sodium hydroxide to a polyallylamine salt, in the presence of the alkylating agents 1-bromodecane and (6-bromohexyl)-trimethylammonium bromide; one of the crosslinking agents glycidyl tosilate and epichlorohydrin is added after approximately 1 hour.

The polyallylamine salt is preferably polyallylamine hydrochloride.

In a further aspect, the present invention relates to the Colesevelam obtainable by the process of the present invention.

Although the invention has been described in its characteristic aspects, modifications and equivalents that are apparent to the person skilled in the art are included in the following invention.

The present invention will now be illustrated by means of some examples, which should not be viewed as limiting the scope of the invention.

### EXAMPLE 1

In a reaction flask, a 50% solution of polyallylamine hydrochloride in water (10.56 g) and sodium hydroxide (3.76 g) were charged, while maintaining the temperature below 30° C. (6-Bromohexyl)-trimethylammonium bromide (6.38 g) and 1-bromodecane (3.81 g) in acetonitrile (25 ml) were then charged. The temperature was brought to about 67° C., and the reaction mixture was kept under these conditions for about 1 hour, glycidyl tosilate (1 g) was then charged, and the reaction mixture was kept at a temperature of 67° C. for about four hours. Once the reaction was completed, the temperature was brought to room temperature, the reaction mixture was filtered at a basic pH, and the solid obtained was washed with acetonitrile (2×10 ml). The washed solid was suspended in water (100 ml), left under stirring for about 30 minutes, filtered again and washed with water (1×50 ml), and suspended in a 2N sodium chloride solution (180 ml). The solid was kept under stirring for about 30 minutes, was filtered and suspended again in a 2N sodium chloride solution (180 ml). The solid was kept under stirring for about 30 minutes, was filtered and suspended in water (100 ml); the pH was adjusted to a value comprised between 4 and 5 with 37% hydrochloric acid, the mixture was kept under stirring for about 30 minutes, and it was filtered. The solid obtained was washed with water (3×100 ml) and dried in a vacuum oven at 50° C., to give 8 g of Colesevelam.

### EXAMPLE 2

In a reaction flask, a 50% solution of polyallylamine hydrochloride in water (10.56 g) and sodium hydroxide (3.76 g) were charged, while maintaining the temperature below 30° C. (6-Bromohexyl)-trimethylammonium bromide (6.38 g), 1-bromodecane (3.81 g) in acetonitrile (25 ml) and glycidyl tosilate (1 g) were then charged. The temperature was brought to about 67° C., and the reaction mixture was kept under these conditions for about 4 hours. Once the reaction was completed, the temperature was brought to room temperature, the reaction mixture was filtered at a basic pH, and the solid obtained was washed with acetonitrile (2×10 ml). The washed solid was suspended in water (100 ml), left under stirring for about 30 minutes, filtered again and washed with water (1×50 ml), and suspended in a 2N sodium chloride solution (180 ml). The solid was kept under stirring for about 30 minutes, was filtered and suspended again in a 2N sodium chloride solution (180 ml). The solid was kept under stirring for about 30 minutes, was filtered and suspended in water (100 ml); the pH was adjusted to a value comprised between 4 and 5 with 37% hydrochloric acid, the mixture was kept under stirring for about 30 minutes, and it was filtered. The solid obtained was washed with water (3×100 ml) and dried in a vacuum oven at 50° C., to give 8 g of Colesevelam.

### EXAMPLE 3

In a reaction flask, a 50% solution of polyallylamine hydrochloride in water (10.56 g) and sodium hydroxide (3.76 g) were charged, while maintaining the temperature below 30° C. (6-Bromohexyl)-trimethylammonium bromide (6.38 g) and 1-bromodecane (3.81 g) in acetonitrile (25 ml) were then charged. The temperature was brought to about 67° C., and the reaction mixture was kept under these conditions for about 1 hour, epichlorohydrin (0.40 g) was then charged, and the reaction mixture was kept at a temperature of 67° C. for about four hours. Once the reaction was completed, the temperature was brought to room temperature, the reaction mixture was filtered at a basic pH, and the solid obtained was washed with acetonitrile (2×10 ml). The washed solid was suspended in water (100 ml), left under stirring for about 30 minutes, filtered again and washed with water (1×50 ml), and suspended in a 2N sodium chloride solution (180 ml). The solid was kept under stirring for about 30 minutes, was filtered and suspended again in a 2N sodium chloride solution (180 ml).

The solid was kept under stirring for about 30 minutes, was filtered and suspended in water (100 ml); the pH was adjusted to a value comprised between 4 and 5 with 37% hydrochloric acid, the mixture was kept under stirring for about 30 minutes, and it was filtered. The solid obtained was washed with water (3×100 ml) and dried in a vacuum oven at 50° C., to give 9 g of Colesevelam.

1. Process for the synthesis of Colesevelam comprising reacting, in a basic environment, polyallylamine with:
i) at least one alkylating agent of formula X—(CH₂)₉—CH₃ and at least one alkylating agent of formula Y—(CH₂)₆—N⁺(CH₃)₃Z⁻, wherein X and Y are each independently a leaving group, and Z is a halogen; and
ii) at least one crosslinking agent, wherein said at least one alkylating agent of formula X—(CH₂)₉—CH₃, said at least one alkylating agent of formula Y—(CH₂)₆—N⁺(CH₃)₃Z⁻, and said at least one crosslinking agent are reacted with polyallylamine simultaneously.

2. Process for the synthesis of Colesevelam comprising reacting, in a basic environment, polyallylamine with:
i) at least one alkylating agent of formula X—(CH₂)₉—CH₃ and at least one alkylating agent of formula Y—(CH₂)₆—N⁺(CH₃)₃Z⁻, wherein X and Y are each independently a leaving group, and Z is a halogen; and
ii) at least one crosslinking agent, wherein said at least one alkylating agent of formula X—(CH₂)₉—CH₃ and said at least one alkylating agent of formula Y—(CH₂)₆—N⁺(CH₃)₃Z⁻ are reacted with polyallylamine before said at least one crosslinking agent.

3. Process according to the claim 1, wherein said leaving group is a halogen or a group of formula —OSO₂R, wherein R is selected from trifluoromethyl, p-tolyl, methyl, m-nitro-phenyl.

4. Process according to the claim 1, wherein Z is bromine.

5. Process according to claim 1, wherein said alkylating agent of formula X—(CH₂)₉—CH₃ is 1-bromodecane.

6. Process according to claim 1, wherein said alkylating agent of formula Y—(CH₂)₆—N⁺(CH₃)₃Z⁻ is (6-bromohexyl)-trimethylammonium bromide.

7. Process according to claim 1, wherein said at least one crosslinking agent is selected from: 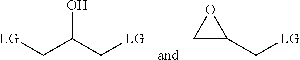
wherein LG is a leaving group.

8. Process according to the claim 7, wherein said leaving group is a halogen or a group of formula —OSO₂R, wherein R is selected from trifluoromethyl, p-tolyl, methyl, m-nitro-phenyl.

9. Process according to the claim 7, wherein said compound of formula 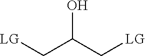
is 1,3-dichloropropan-2-ol.

10. Process according to the claim 7, wherein said compound of formula 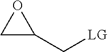
is epichlorohydrin, glycidyl tosilate or epibromohydrin.

11. Process according to claim 1 carried out in a polar solvent, selected from water, acetonitrile or a mixture thereof.

12. Process according to claim 1 carried out at a pH ranging between 8 and 14.

13. Process according to claim 2, wherein said crosslinking agent is reacted with the intermediate thus obtained, without isolating the same.

14. Colesevelam obtainable by the process according to claim 1.

15. Process according to claim 3, wherein said leaving group is bromine.

16. Process according to claim 8, wherein said leaving group is chlorine, bromine or p-toluensulphonate.
